(19) United States
(12) Patent Application Publication
(10) Pub. No.: US 2010/0279604 A1
(43) Pub. Date: Nov. 4, 2010

(54) Intersatellite Links

(75) Inventor: Lloyd H. Wood, Surrey (GB)

Correspondence Address: EDELL, SHAPIRO & FINNAN, LLC, 1901 RESEARCH BOULEVARD, SUITE 400, ROCKVILLE, MD, 20850, US

(73) Assignee: CISCO TECHNOLOGY, INC., San Jose, CA (US)

(21) Appl. No.: 12/435,052

(22) Filed: May 4, 2009

(51) Int. Cl. H04B 7/185

(52) U.S. Cl. 455/12.1

(57) ABSTRACT

A first satellite and a second satellite are deployed in a cluster in closely related orbits around the Earth. The second satellite has at least one light emitting diode (LED) configured to transmit optical signals to the first satellite to enable an intersatellite link (ISL) between the first and second satellites.

### TECHNICAL FIELD

Embodiments of the present invention are related to satellite communications, and more particularly to intersatellite communication.

### BACKGROUND

With a traditional ‘bent-pipe’ geostationary satellite, the satellite link is treated as just that: a single link in each direction between ground terminals. Although this link consists of an uplink followed by amplification, frequency downshifting and a downlink returning the signal content to the ground, the single satellite link budget includes all of these steps combined. There is a strong relationship—a codependency—between a signal's uplink and its downlink.

Often, even when demodulating or decoding a signal to baseband onboard the satellite, the relationship between the design of the uplink and the downlink remains very strong. This codependency can make for clarity of design and engineering optimization when the satellite is used for its intended purpose. This coupling between uplink and downlink can also permit flexibility in use of the single established channel through both the uplink and downlink that results, e.g., in allowing ground terminals to use turbo coding across links using satellites deployed before turbo coding had been developed, without requiring changes to the satellites. The frequency band that is amplified by the satellite remains unchanged.

However, this codependency can also limit the flexibility of link use, terminal design, and the range of networking services that can be offered by available satellite capacity as a whole. To this end, satellite on-board processing (OBP) can be used to decrease this uplink/downlink codependency. Increased on-board processing and switching capabilities on computationally ‘smarter’ satellites can introduce bridging and then networking functionality within and between satellites. The uplink and the downlink can be configured to use entirely different frequencies and modulation schemes, while carrying higher-level protocol information, such as packets or datagrams. This makes the uplink and downlink separate links.

Breaking the link dependency entirely can increase the flexibility of use of each satellite's uplink, downlink and payloads in various ways not envisaged by the original link designers. Links can be connected together or used as required, or on-demand. For example, data sent up one uplink can be processed and sent down a variety of different downlinks, data from a variety of uplinks can be combined and sent down one downlink, or other scenarios combining multiple uplinks and downlinks can be supported.

One way to take advantage of this separation of uplink and downlink is to interconnect multiple satellites or spacecraft by using direct communication links, commonly called intersatellite links (ISLs). With ISLs, it is possible to eliminate or reduce satellite-to-ground station hops, thereby decreasing latency and increasing overall network capabilities, among other advantages. The uplink and downlink paths for data can even be on entirely separate satellites, as the uplinks and downlinks have been decoupled. While some existing systems employ ISLs, improvements are still desirable.

### BRIEF DESCRIPTION OF THE DRAWINGS

FIG. 1 shows a network in which embodiments of the present invention can be deployed;

FIG. 2 depicts a satellite and ground stations that comprise part of a network and in which embodiments of the present invention can be deployed;

FIG. 3 shows several satellites arranged in a satellite cluster in accordance with an embodiment of the present invention;

FIG. 4 shows a body of a satellite having multiple cones for achieving intersatellite links using LEDs in accordance with an embodiment of the present invention;

FIG. 5 is a detailed illustration of a set of LEDs that may arranged in a reflector in accordance with an embodiment of the present invention;

FIG. 6 shows an advanced satellite having an intersatellite link with another satellite in accordance with an embodiment of the present invention;

FIG. 7 is a block diagram of a series of components for implementing an intersatellite links using LEDs in accordance with an embodiment of the present invention;

FIG. 8 is a flowchart showing steps for performing a method in accordance with an embodiment of the present invention; and

FIG. 9 is a block diagram of a receive side of an LED-based intersatellite link in accordance with an embodiment of the present invention.

FIG. 10 shows another embodiment for an arrangement of LEDs for an intersatellite link in accordance with an embodiment of the present invention.

### DESCRIPTION OF EXAMPLE EMBODIMENTS

### Overview

Embodiments of the present invention provide, among other things, a system comprising a first satellite and a second satellite, where the second satellite has at least one light emitting diode (LED) configured to transmit optical signals to the first satellite to enable an intersatellite link (ISL) between the first and second satellites. The first and second satellites may be placed in substantially the same orbit around the Earth, other planet or moon, and together form what is referred to herein as a local satellite cluster. That is, the satellites (first, second, or more) may orbit together in a low Earth orbit or other orbit, or may occupy an allocated slot in geostationary orbit. These satellites are connected together to form a network node or networking ‘cloud’ that may function, from the perspective of ground stations and other network elements, as a single satellite that orbits the main body and, if geostationary, is said to occupy the allocated geostationary slot. It is noted that the term “satellite” may also be interpreted to include space probes or relays.

In one embodiment, LEDs or sets of LEDs are arranged around the exterior of the satellites so that the second satellite can transmit optical signals to multiple relatively close satellites that comprise the satellite cluster.

Current thinking on intersatellite link communication is that either the links are radio-based (e.g. operationally in the existing Iridium low-Earth-orbiting (LEO) satellite constellation), or laser-based (as proposed for the Teledesic broadband constellation that was never built, but since demonstrated in experimental LEO/GEO connections, by e.g. SILEX and Artemis). Laser hardware with tracking and buffering to cope with LEO orbits and the resulting Doppler effects is presently commercially available.

Intersatellite links (ISLs) for geostationary satellites can be classified according to the distance between the communicating satellites:

(a) Long-distance ISLs: connecting geostationary satellites that are far apart. An example of this is the long connections outlined in Arthur C. Clarke's 1945 paper in wireless communications, namely making a triangle around the Earth, or the connections intended for the satellite components of the US Milstar and Advanced Extremely High Frequency (AEHF) systems. Since these links are long distance (tens of thousands of kilometers through free space), use of highly directed lasers is necessary.

In any event, such long distance ISLs are not that useful for interactive network communications, as they add to the end-to-end path delay that the geostationary satellite uplink and downlink are already a large part of. This long path delay degrades the performance of many networking communication protocols such as the Transmission Control Protocol (TCP), and is not good for real-time use.

(b) Short-distance ISLs: between satellites or spacecraft that are relatively near to each other (hundreds or tens of kilometers) and stationkeeping together as a nearby, self-contained, cluster. The idea here is that the satellites interact to create a ‘virtual satellite’ that is more than the sum of its parts, and made up out of all the communicating satellites.

Because these local links are much shorter distance, use of lasers and accurate pointing is considered to be an excessively expensive approach. Instead, the conventional thinking is that such local links will be high-frequency wireless links, because in the vacuum of space, without atmospheric loss or rain fade to contend with in the link budget, only free space loss, proportional to the square of the distance between transmitter and receiver, is a problem. And the distances are short, so the loss is much less than with the long-distance links described earlier in (a). Further, direct pointing is not needed, and a wide beam spread to encompass a swath of volume where a neighboring satellite will be good enough—mass and power are saved from not having a complex laser pointing mechanism, and a wider beam spread than a laser's is permissible to encompass the varying position of the neighboring satellite. Broadcast communication that is shared by multiple neighboring satellites becomes possible.

However, there is a problem. A satellite is already a complex wireless radiation environment, as a result of the uplinks and downlinks and supporting transponders it carries. That wireless equipment generates complex radiation patterns, electromagnetic interference with the other satellite components and radio frequency testing is not straightforward, and can take months in radio chambers.

Communication among a local cluster of satellites can introduce additional short-range wireless transmitters to the satellite, which further complicates the radiation environment, and can adversely affect uplinks and downlinks via sidelobes and harmonics. This is a problem preventing use of wireless intersatellite links, or at least complicating testing and assembly of the entire satellite. The various radio components (uplinks/downlinks, transponders, intersatellite links) need to be designed with awareness of how they affect each other, rather than having a truly modular design where separate parts are just assembled.

The problem of interference from short-range wideband radio intersatellite links on satellites and transponders at geostationary orbit has not received attention. Indeed, it is believed that no one has attempted to use such links operationally, so it has not been encountered in practice.

It is in this context that embodiments of the present invention are provided. That is, in a satellite cluster formation, rather than using expensive laser ISLs with heavy pointing and tracking assemblies, or unwieldy and interference-prone radio-frequency ISLs, embodiments of the present invention employ, instead, one or more light emitting diodes (LEDs) to transmit optical signals from one sister satellite to another sister satellite in the orbiting satellite cluster.

While LED optical communication has been used successfully terrestrially across the proposed distance between satellites (see, e.g., LED Communications over a 104-Mile Path, Stan Horzepa, ARRL, Jul. 14, 2006), no one to date has proposed an LED-based short-range optical intersatellite link to avoid the radio interference with other components that would be created by use of short-distance wireless intersatellite links.

Embodiments of the present invention simplify integration of ISLs with radio payloads' radio downlinks. Use of inexpensive LED technology for relatively close communication also avoids the cost, complexity, over-engineering and directionality of optical laser ISLs intended for long distances, while extending link lifespan, as LEDs last longer in operation than lasers. LEDs can provide wide-area communication, and diffusion lenses can be used in front of the LEDs to increase and control beam spread.

Thus, in accordance with embodiments of the present invention, an LED-based short-range intersatellite link is employed to communicate between satellites, avoiding electromagnetic interference with other radio transponders onboard the satellites and simplifying electromagnetic testing and payload integration for the satellites. No added electromagnetic interference from intersatellite-link radio transponders needs to taken into account, as optical light is easily absorbed by or reflected from the surface of satellite body.

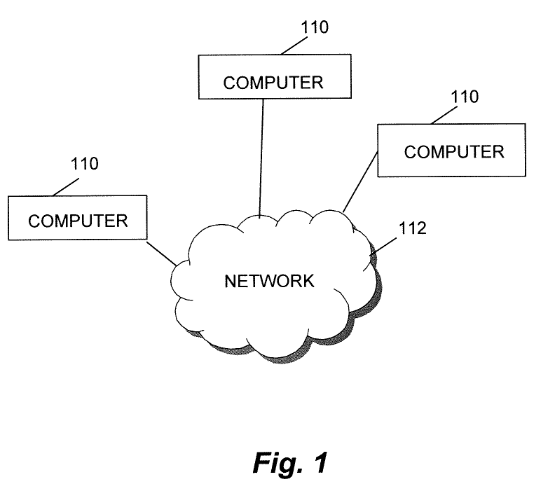

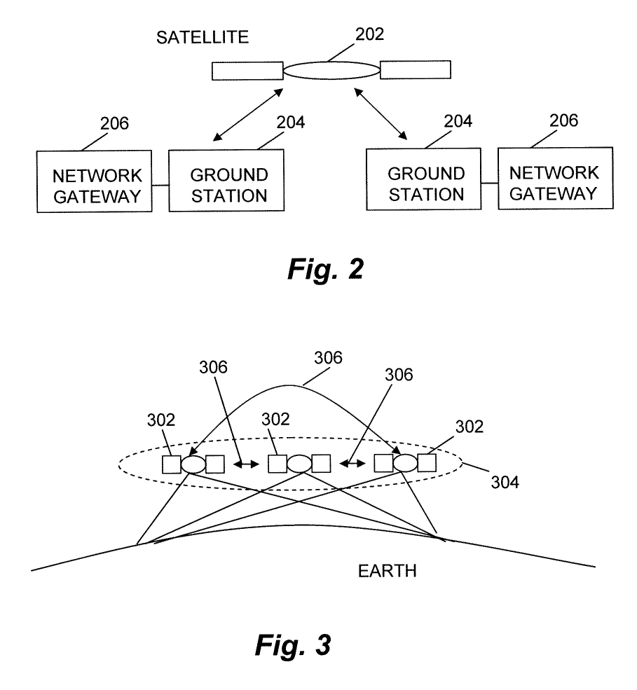

Referring now to FIG. 1, there is shown an overall system 100 that includes a plurality of computers or computing or electronic devices 110 that are in communication with each other via a network 112. Network 112 may comprise the public Internet, a private network, or any combination of such electronic networks (including wired and wireless implementations thereof). As will be appreciated by those skilled in the art, and as shown in FIG. 2, a satellite 202 may form part of network 112. More specifically, one or more ground stations 204, which are often (covers LEO cases) in communication with satellite 202 are often also in communication with a network gateway 206 that enables the satellite to seamlessly pass network data via its uplink and downlink transponders.

FIG. 3 shows several satellites 302 arranged in a cluster 304 where each satellite 302 is in communication with another satellite 302 via an ISL 306. Although not shown, the satellites 302 may be arranged in a triangle formation in substantially the same plane (i.e., in substantially the same geostationary orbit around the Earth) such that each of the satellites has line-of-sight with the other satellites in the cluster 304. Further, although three satellites 302 are shown, as few as two, or more than three satellites may comprise a single satellite cluster in accordance with embodiments of the present invention. As further shown in FIG. 3, each of the satellites has a certain coverage area on the Earth. Of course, those coverage areas may also be different for each of the satellites, and may change over time for non-geostationary satellites.

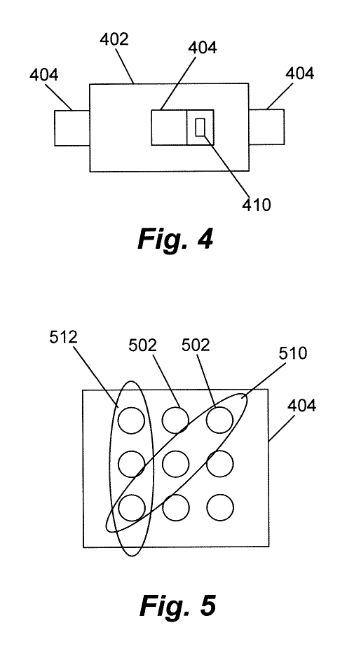

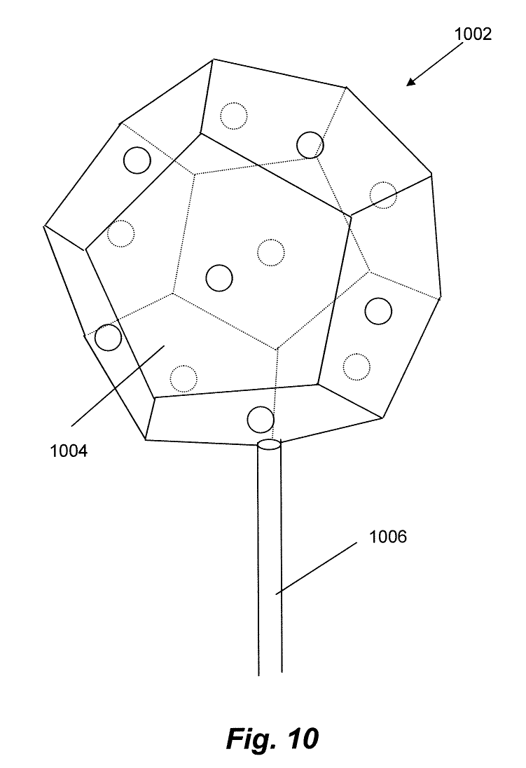

FIG. 4 shows a body 402 of a satellite 302 having multiple reflectors 404 for achieving intersatellite links using LEDs in those reflectors in accordance with an embodiment of the present invention. As shown, the cones 404, and thus the LEDs 502 mounted therein (as shown in FIG. 5), are arranged around an exterior of the body 402 of the satellite so that the LEDs 502 can have line-of-sight to sister satellites 302 in the cluster 304. Cones 404 can be arranged at 120° intervals, at 90° intervals, or any other interval that is suitable to ensure that the plurality of satellites 302 in a given satellite cluster 304 can communicate with one another. In one such embodiment of reflectors shown in FIG. 10, each conical reflector 1004 containing an LED at its focal point is angled so that its outward face forms the face of a regular polyhedron 1002, so that all possible directions are visible from a reflector. This communications polyhedron may be mounted away from the satellite body on a rod 1006, so that the satellite body does not obstruct communication. LED photodetectors may be mounted in a similar assembly, or may be mounted alongside the LEDs in the same reflectors provided that the photodetectors are tuned to selected frequencies other than those emitted by their neighboring LEDs.

FIG. 4 also depicts a photodetector 410 that may be used to receive optical signals generated by LEDs on other satellites. Typically, a satellite will have the same number of photodetectors as cones 404, although there could be fewer or more photodetectors. Further, photodetectors 410 may be mounted in the same cone as the LEDs or in separate cones.

Referring again to FIG. 5, LEDs 502 may be pulsed in unison, or may alternatively be pulsed separately, sequentially or in groups. Reference numerals 510 and 512 depict possible groupings of the LEDs 502 for pulsing purposes. Multiple groupings may be employed as well. Pulsing in groups may be beneficial in increasing overall optical power output, thereby increasing the likelihood of accurate reception at a sister satellite 302.

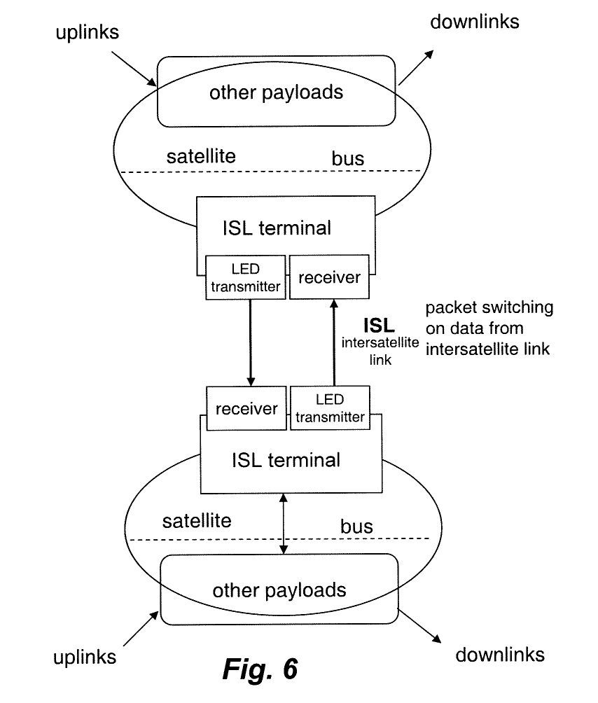

FIG. 6 shows an advanced satellite having an intersatellite link with another satellite in accordance with an embodiment of the present invention. As shown, the satellites include networked communication busses, allowing different satellite payloads to communicate with one another. Thus, not only does each satellite communicate with a ground station via uplinks and downlinks, as shown, but the intersatellite link enables uplinks and downlinks on different satellites to be used to complete a communications path. Further information about the use of ISLs in satellite clusters can be found in Slot Clouds: Getting More from Orbital Slots with Networking, L. Wood, A. Da Silva Curiel, J. Anzalchi, D. Cooke, C. Jackson, 54th International Astronautical Congress, Bremen, Germany (2003), which is incorporated herein by reference.

As further shown, an ISL between the satellites may be implemented using one or more LEDs as discussed above. As also noted above, each satellite preferably also includes a photodetector (receiver) for receiving optical signal transmissions from the LED(s). Data passed via ISL may include satellite control information, routable data, network packets or datagrams, or any other data for which it may be desirable to pass between satellites.

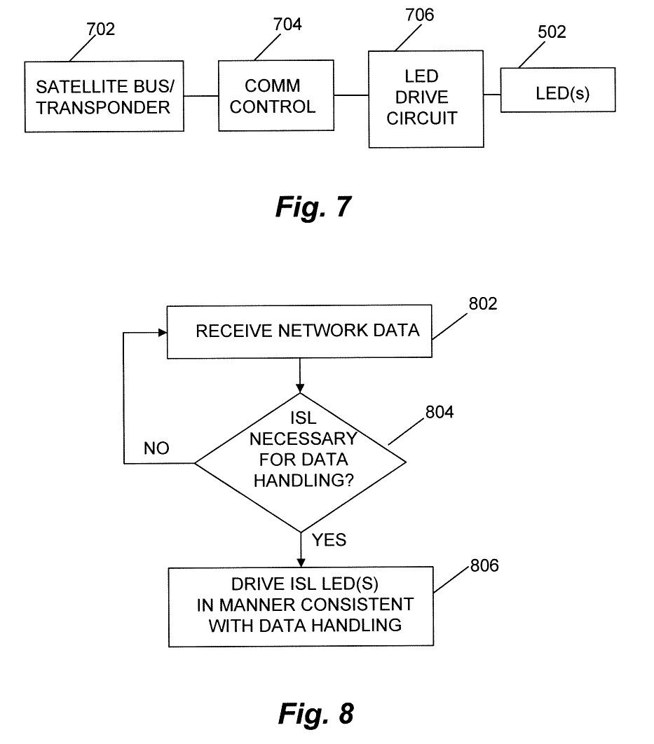

FIG. 7 is a block diagram of a series of components for implementing an intersatellite link using LEDs in accordance with an embodiment of the present invention. Using the satellite example of FIG. 6, it is desired that some portion of data is to be transmitted via an ISL. The data could be made available via a transponder or via an internal bus of the satellite, module 702. This data may then be passed to communication control module 704. Communication control module 704 may be used to (1) determine whether the data is to be sent via ISL and/or (2) to modulate the data in a particular manner, among other things, to prepare the same for transmission via the ISL. Data, perhaps modulated by communication control module 704, is then passed to LED drive circuit 706. LED drive circuit 706 may be used to drive one or more of the LEDs 502 shown in FIG. 5. The LEDs may be driven or “pulsed” singly, in unison, sequentially, or in groups in accordance with any predetermined pattern or convention.

FIG. 8 is a flowchart showing steps for performing a method in accordance with an embodiment of the present invention. At step 802, data is received within a satellite. The data may have been received directly from an uplink transponder, or via a networked bus from an independent payload carried by the satellite. At step 804, it is determined whether an intersatellite link is desired/necessary to handle or process the data. If not, then the process returns to step 802 where further data is received. If, on the other hand, an ISL is desired or necessary to handle the data, then the LED(s) are driven in a manner consistent with handling the data, namely, the LED(s) are driven such that optical signals are transmitted to a sister satellite in the same cluster. Possible modulation techniques for the LEDs include, but are not limited to, pulse code modulation, pulse position modulation, or other modulation methods and techniques.

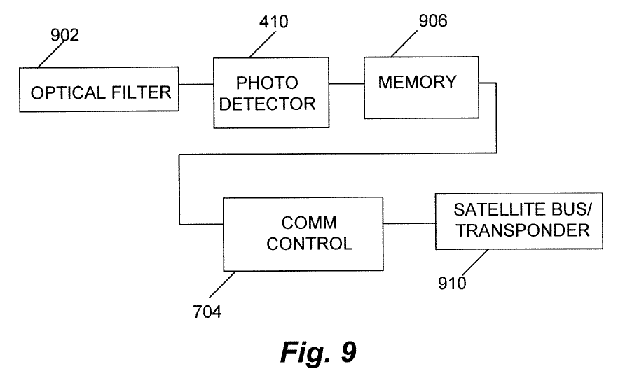

FIG. 9 is a block diagram of a receive side of an LED-based intersatellite link in accordance with an embodiment of the present invention. The LED transmitted optical signals from a first satellite are preferably first filtered via an optional optical filter 902 to filter out as much extraneous/background light as possible (i.e., a filter that is tuned to pass the wavelengths of light of the LED(s). The remaining light is then cast on the photodetector (or multiple photodetectors) 410. An output of the photodetector is then sampled (not shown) and stored in memory 906 as appropriate. The stored digitized data (resulting from sampling) may then be demodulated by, e.g., communication control module 704, as necessary, and then the resulting original data is passed to the satellite bus or transponder 910 of the receive side satellite. In this manner, data from a first satellite can be passed to a second satellite that is stationed relatively close by (e.g., within a distance suitable for a cluster of satellites, e.g. those stationed in substantially the same geostationary orbit and within hundreds or tens of kilometers of each other).

Referring back to FIG. 6, the satellites therein are shown having both a LED transmitter and a photodetector receiver. Such a configuration will support bi-directional communication between the two satellites. However, those skilled in the art will appreciate that it is possible that within a cluster some satellites might have only a receiver, while others might have only LED transmitters. In such a case, only uni-directional communication is supported. Alternatively, one can consider each LED transmitter/receiver pair to support uni-directional communication.

It is noted that the transmitting and receiving satellites are oriented with respect to one another such that respective LED(s) and photodetectors are directed in each others' general direction. Alternatively, or in addition, the LEDs themselves (or a mounting on which they are disposed) may be oriented independently of the satellite.

Since, in accordance with embodiments of the present invention, very-high-frequency light photons are generated (optical signals), rather than a large electromagnetic field from lower-frequency high-radio-frequency transmitters, the problems associated with electromagnetic interference can be avoided.

Further, LED light is easily blocked by the satellite body and directed, unlike radio-frequency waves. Thus, multiple LEDs in separate conic reflectors can coexist next to one another, pointing in different directions to concentrate coverage and increase intensity, without interference with each other or with other components onboard the satellite.

One of many possible uses of embodiments of the present invention include intersatellite links interconnecting communicating modems onboard a satellite.

It is anticipated that operators of geostationary or stationkeeping spacecraft would be most likely to adopt features of embodiments of the present invention. These operators, for example, might own several satellites in close proximity, likely in an allocated ‘orbital slot’ in geostationary orbit. The satellites might pass network traffic, sent to and from ground destinations and sources, or originated onboard the satellites, between themselves by using the LED intersatellite links. These ‘clusters’ of satellites might also be connected to other ‘remote’ clusters of satellites by a satellite in each cluster hosting a long-distance radio or laser ISL terminal, but that is not a requirement.

In sum, described herein is a new approach to intersatellite links. In accordance with an embodiment of the present invention, a first satellite is provided along with at least a second satellite. The second satellite has at least one light emitting diode (LED) configured to transmit optical signals to a receiver on the first satellite to enable an intersatellite link between the first and second satellites. For bidirectional communication, the first satellite can also have an LED configured to transmit to a receiver on the second satellite.

In accordance with another embodiment, a plurality of light emitting diodes (LEDs) is arranged around an outside of a satellite. An LED drive circuit is configured to selectively drive the plurality of LEDs. A communication control module is configured to determine whether data received at the satellite is to be communicated to a second satellite via an intersatellite link, and when the data received at the satellite is to be communicated to another satellite to indicate to the LED drive circuit to drive at least one of the plurality of LEDs to transmit optical signals to the second satellite.

Although the apparatus, system, and method are illustrated and described herein as embodied in one or more specific examples, it is nevertheless not intended to be limited to the details shown, since various modifications and structural changes may be made therein without departing from the scope of the apparatus, system, and method and within the scope and range of equivalents of the claims. Accordingly, it is appropriate that the appended claims be construed broadly and in a manner consistent with the scope of the apparatus, system, and method, as set forth in the following.

What is claimed is:

1. A system, comprising:
a first satellite; and
a second satellite, the second satellite having at least one light emitting diode (LED) configured to transmit optical signals to an optical receiver of the first satellite to enable an intersatellite link between the first and second satellites.

2. The system of claim 1, wherein the first and second satellites are in substantially the same orbit around the Earth, other planet or moon.

3. The system of claim 1, wherein the at least one LED is one of a plurality of LEDs arranged in a communication cone of the second satellite.

4. The system of claim 3, wherein the second satellite comprises a plurality of communications reflectors respectively having arranged therein a plurality of LEDs.

5. The system of claim 4, wherein the plurality of communications reflectors are arranged laterally around the second satellite.

6. The system of claim 1, wherein the second satellite comprises an LED drive circuit.

7. The system of claim 6, wherein the LED drive circuit is configured to drive a plurality of LEDs.

8. The system of claim 1, wherein the first satellite comprises a photodetector configured to receive the optical signals from the second satellite.

9. The system of claim 8, further comprising an optical filter tuned to wavelengths of light emitted by the at least one LED.

10. The system of claim 1, wherein the optical signals include satellite control information, network data, or communication information.

11. The system of claim 1, wherein the LED is mounted on a polyhedron spaced from the second satellite.

12. A satellite, comprising:
a plurality of light emitting diodes (LEDs) arranged around an outside of the satellite;
an LED drive circuit configured to selectively drive the plurality of LEDs;
a communication control module configured to determine whether data received at the satellite is to be communicated to another satellite via an intersatellite link (ISL), and when the data received at the satellite is to be communicated to another satellite to indicate to the LED drive circuit to drive at least one of the plurality of LEDs to transmit optical signals to the another satellite.

13. The satellite of claim 12, wherein the plurality of LEDs are arranged in groups, where each group is arranged around the satellite.

14. The satellite of claim 13, wherein each of the groups is arranged in a communications cone mounted to the satellite.

15. The satellite of claim 12, wherein the satellite is configured to orient itself or the LEDs mounted thereon such that at least one of the plurality of LEDs is facing a direction of the another satellite.

16. The satellite of claim 15, wherein the satellite and another satellite are in substantially the same geostationary orbit around the Earth.

17. A method, comprising:
receiving at a satellite data via an uplink;
determining whether an intersatellite link (ISL) is necessary for handling the data; and
when it is determined that an ISL is necessary for handling the data, driving an LED arranged on an exterior of the satellite to transmit optical signals consistent with the data, where the optical signals are received by another satellite.

18. The method of claim 17, further comprising driving a plurality of LEDs.

19. The method of claim 17, further comprising filtering the optical signals at the another satellite.

20. The method of claim 17, further comprising demodulating the optical signals at the another satellite.
